(19) United States
(12) Patent Application Publication
(10) Pub. No.: US 2009/0287729 A1
(43) Pub. Date: Nov. 19, 2009

(54) SOURCE CODE COVERAGE TESTING

(75) Inventors: Yuan Chen, Issaquah, WA (US); Newton Sanches, Sammamish, WA (US); Nataraj Venkataramaiah, Sammamish, WA (US); Sudhakar Sannakkayala, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/121,801

(22) Filed: May 16, 2008

(51) Int. Cl. G06F 11/36; G06F 17/30

(52) U.S. Cl. 707/102; 717/127; 717/106; 707/E17.005

(57) ABSTRACT

Code coverage testing of an application (e.g., to determine which blocks of source code are executed during run-time testing) in an operating system is accomplished using instrumented code and a performance analysis profiler. That is, non-executable code statements (e.g., T-SQL in-line comments) are injected into the source code at respective executable statements, and metadata is generated for respective source code elements. The performance analysis profiler monitors the testing of the application, generating trace data. Trace data is combined with metadata to generate code coverage reports for the application's source code, which provide, among other things, an indication of the thoroughness of the test (e.g., number of available application instructions that are actually executed during the test).

### BACKGROUND

Application code has become increasingly complex, and as complexity has increased so has a need to perform application testing. Application testing allows one to determine, among other things, whether an application's code has proper functionality. However, technicians and programmers may also wish to test effectiveness of an application testing program or system. Code coverage testing can be used to determine which portions of an application's code are being executed during tests against the application, and thus how effective or thorough different tests are that the application is being run through.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Code coverage techniques are increasingly used to assess effectiveness of application testing. Code coverage involves determining which portions of an application's code are executed when an application is subjected to testing. Path tracing is performed by recording instructions that are being executed by the tested application. Further, the application's code coverage can be tested under a variety of circumstances, enabling a programmer to fine tune an application testing program. Test effectiveness is typically measured in ratio or percentage of a number of instructions executed during the test to a total number of instructions present in the application. As an example, a test may be regarded as moderately effective where 70 instructions are executed in an application that comprises 100 instructions.

Existing code coverage instrumentation and reporting tools, typically used by application developers and quality assurance professional to test effectiveness of their application testing methodologies, for example, inject external stored procedure calls as executable statements into the application code. However, injecting these executable statements into the application code can result in altered functionality of the application code, making it inefficient and unsuitable in certain circumstances.

As provided herein, techniques and systems are disclosed for application code coverage testing, whereby the application's functionality undergoes little to no alteration, the testing is more efficient, and is cross-platform functional. The techniques and systems parse the application's source code into elements (e.g., procedures, functions, triggers, and/or calls), and collect metadata concerning executable statements, code structure, and the source code itself. The source code is instrumented, whereby non-executable statements (e.g., in-line comments) are injected into the source code, for example, at a beginning of respective executable statement blocks. The instrumented code is introduced into an operating system (e.g., SQL code may be instrumented with T-SQL in-line comments, and the instrumented code is introduced into an SQL Server system), and application testing is performed. During testing, a performance analysis profiler monitors the application run-time, generating trace data for the respective executed statements. The trace data is mapped to the source code using metadata generated during the instrumentation process, and code coverage reports are created that show which lines of executable statements were covered during the run-time.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow chart illustrating an exemplary method of source code coverage testing.

FIG. 2 is a flow chart illustrating an exemplary portion of a method of source code coverage testing, showing source code parsing.

FIG. 3 is a flow chart illustrating an exemplary portion of a method of source code coverage testing, showing code instrumentation.

FIG. 4 is a flow chart illustrating an exemplary portion of a method of source code coverage testing, showing coverage data table generation.

FIG. 5 is a flow chart illustrating an exemplary portion of a method of source code coverage testing, showing code coverage testing.

FIG. 6 is an illustration of exemplary source code before and after instrumentation.

FIG. 7 is a block diagram illustrating an exemplary implementation of source code coverage testing.

FIG. 8 is a block diagram illustrating an exemplary portion of an implementation of source code coverage testing, whereby trace data is generated.

FIG. 9 is a component block diagram illustrating an exemplary system for source code coverage testing.

FIG. 10 is a component block diagram illustrating an alternate exemplary system for source code coverage testing.

FIG. 11 is an illustration of an exemplary computer-readable medium comprising processor-executable instructions configured to embody one or more of the provisions set forth herein.

FIG. 12 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

Applications are often tested under a variety of situations to determine proper functionality under tested conditions, and so that application developers may fine tune the application to work more efficiently and effectively. Application source code coverage is used to determine the effectiveness of an application's testing. Code coverage data is collected while application tests are run in an operating system, recording which blocks in the application code are covered (and/or not covered). Code coverage can be used for a variety of reasons, for example: to determine if additional testing is needed to cover areas of the code not covered; to determine a number of tests needed; to help prioritize where to direct testing efforts; and/or to identify “dead” code that can be removed, for example.

One example of a code coverage testing tool is SQL Code Coverage Instrumentation and Reporting Tools (developed and distributed by Microsoft Corporation of Redmond, Wash.), used by SQL Server application developers. This tool injects executable statements into SQL source code, for example, calls (e.g., calling from one procedure to another) to code-coverage specific stored procedures as executable statements into the source code, often called instrumentation. This instrumentation process collects coverage data from specified stored procedures in the application during the test runs. However, in this example, the use of these executable statements can reset certain system global variables, altering functionality of the stored procedures. Further, this method of instrumentation can create inefficiencies, and may not be used in some circumstances. Additionally, this code coverage tool has certain limitations that may not allow it to include coverage for certain elements of an application's code.

In order to be effective and efficient, it may be desirable that the code coverage testing not alter the functionality of the application. Further, it may be desirable that the code coverage testing be able to be used in a wide variety of application testing circumstances in order to properly test an application. Cross-platform compatibility enables an application developer or quality assurance professional to use familiar tools in a variety of situations.

Embodiments described herein relate to techniques and systems for code coverage testing using non-executable statements to instrument source code, and a performance analysis profiler to generate source code trace data. These embodiment can mitigate altering an application functionality, creating a more efficient and effective code coverage, and are cross-platform compatible, allowing for a wide variety of application testing and an expanded scope of coverage.

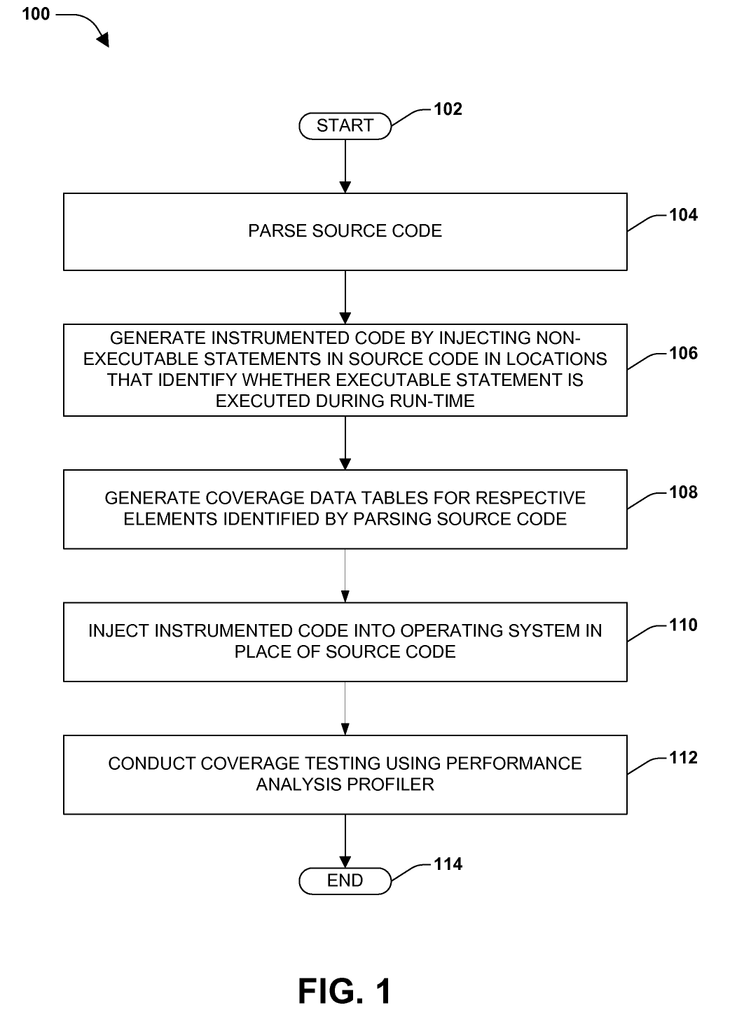

FIG. 1 is an exemplary method 100 for source code coverage testing. The exemplary method begins at 102 and involves parsing the source code at 104, for example, by identifying elements and/or executable statements in the source code. At 106, instrumented code is generated by injecting one or more non-executable statements (e.g., T-SQL in-line comments) into the source code at one or more locations that can indicate whether an executable statement in the source code is executed during run-time. It will be appreciated that the non-executable statements may be injected into the source code at a variety of locations. In this embodiment, the non-executable statements are injected in proximity to one or more of the source code's executable statements' positions, such that when a source code's executable statement is executed during run-time (e.g., when the source code is run in an operating system environment during application testing) the non-executable statement may be able to indicate that the source code's corresponding executable statement was executed.

In the exemplary method 100, at 108, coverage data (e.g., data indicating which executable statements in the source code have been instrumented) tables are generated for respective source code elements identified by the parsing of the source code. The instrumented code is injected into an operating system (e.g., configured to run the source code), in place of the source code at 110. At 112, code coverage testing is conducted using a performance analysis profiler. In this embodiment, it will be appreciated, for example, that the performance analysis profiler performs analysis on the operating system while the instrumented code is running in the operating system during application testing. As an example, database management systems (e.g., SQL Server) may provide profiling subsystems that can efficiently record multiple aspects of the systems execution Ifow for monitoring, debugging and tuning purposes. Having conducted the code coverage testing, the exemplary method 100 ends at 114.

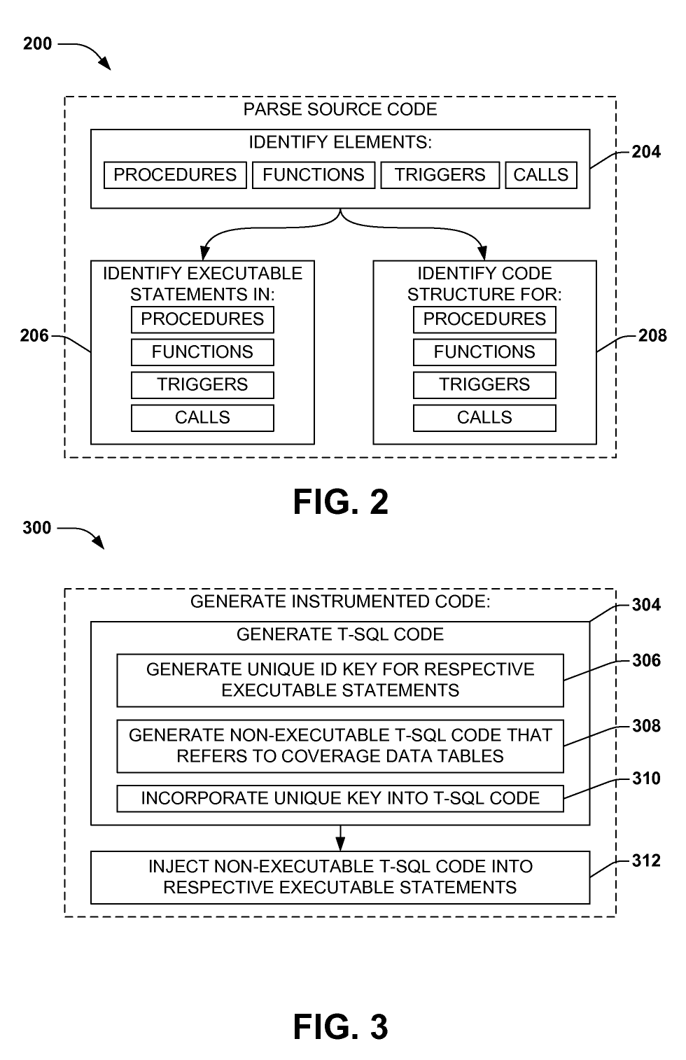

In FIG. 2, an embodiment of an exemplary method 200 for parsing source code (e.g., 104, FIG. 1) is illustrated. In this exemplary embodiment 200, elements of the source code are identified at 204. For example, procedures (e.g., a collection of programming statements that can take and return user-supplied parameters in an operating system or a relational database management system), functions (e.g., predefined programming operations), triggers (e.g., stored procedures that automatically execute when an event occurs), and/or calls (e.g., one procedure calling to another) may be identified during the source code parsing at 204. As an example, the source code may comprise structured query language (SQL), configured to operate on an SQL server system.

In this example, the procedures, functions, triggers and/or calls may comprise executable statements. At 206, one or more executable statements may be identified within the respective identified elements. As an example, when the executable statements are identified, metadata concerning the executable statements may be generated (e.g., information about where the executable statements are located in the source code). At 208, a code structure for identified elements, for example, procedures, functions, triggers, and/or calls, may be identified and metadata concerning the code structure can be created.

The exemplary method 200 provided above is intended to illustrate one embodiment of how source code may be parsed. However, it will be appreciated that an application's source code can comprise a variety of elements, blocks of executable statements, and executable statements, in a variety of combinations, any one of which may be parsed in one or more manners into respective elements and executable statements by those skilled in the art.

In FIG. 3, an embodiment of an exemplary method 300 for generating instrumented code (e.g., 106, FIG. 1) is illustrated. In this exemplary embodiment 300, transact-SQL (T-SQL) code is generated at 304, which involves generating a unique identification key for the respective executable statements identified in a parsing operation (e.g., as in 104 of FIG. 1) at 306. It will be appreciated that unique identification keys, for example, may be a series of increasing integers or other numbers, or one of a variety of identifications used to distinguish respective executable statements from each other.

At 308, in this example, non-executable T-SQL code statements are generated. These statements incorporate references to one or more entries in one or more code coverage data structures (e.g., tables in a database), which may be substantially concurrently populated with code coverage information, when instrumented code is executed during code coverage testing (e.g., as in 112 of FIG. 1). As an example, if a non-executable code statement is later injected into the source code at an executable statement's location, when the executable statement is executed during run-time, the code coverage data structure will be populated with data showing that the statement was executed.

At 310, a unique identification key is incorporated into the non-executable T-SQL code statement, for example, creating a unique, non-executable T-SQL code statement for each of the respective executable statements from the source code. This allows the respective executable statements, for example, to be uniquely identified in the source code so that, if they are later executed during application testing run-time, the code coverage trace data may indicate which of the executable statements were actually executed. At 312, the unique, non-executable T-SQL code statement, generated for each of the respective executable statements from the source code, are injected into the source code, for example, at the beginning of respective executable statements, at 312.

In one aspect, the location that the non-executable statement is placed in the source code can depend on the location and type of executable statements in the code. As an example, executable statements can be subsets of blocks of code that have a single entry point and a single exit point for code flow (e.g., in SQL, executable statement can be atomic units of work executed as part of batches, stored procedures, user defined functions, and triggers, etc.). It will be appreciated that, while this example 300 describes the unique, non-executable statements (e.g., in-line comments) being injected at the beginning of an executable statement, these non-executable statements may be injected into the source code at any location that may indicate whether the respective executable statements have been executed during application testing run-time. Further, in this example, functions and triggers are included in the instrumentation, whereas current code coverage tools may not allow for instrumentation of these elements.

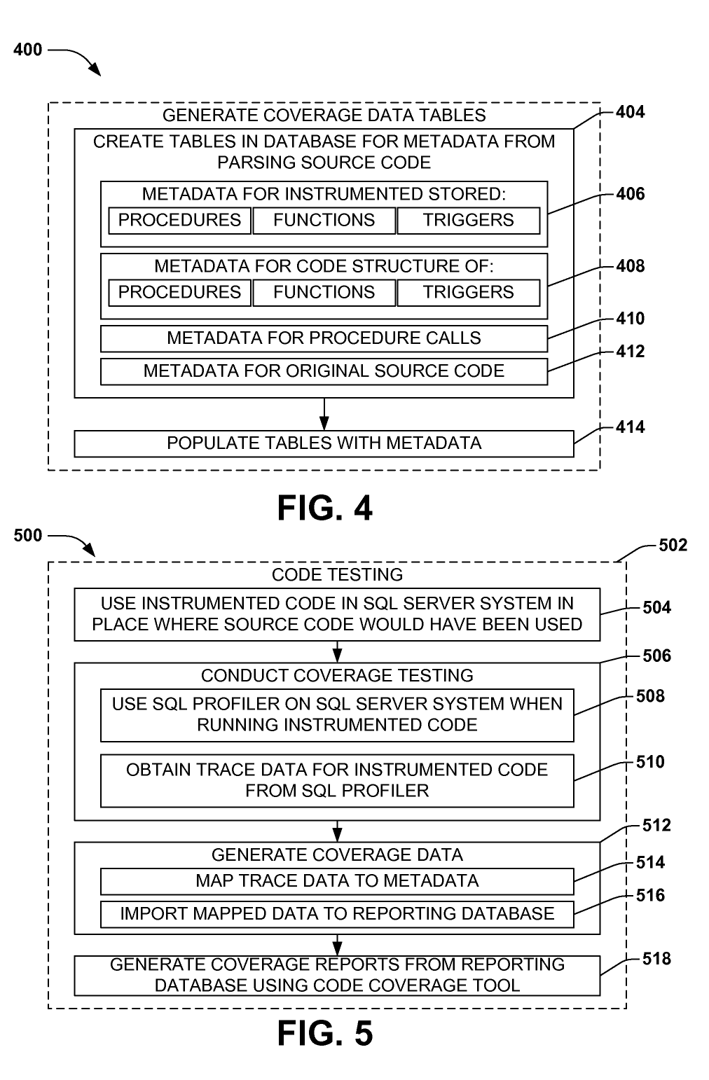

In FIG. 4, an embodiment of an exemplary method 400 for generating data coverage tables (e.g., as in 108 from FIG. 1) is illustrated. In this exemplary embodiment 400, tables for metadata from parsing the source code (e.g., as in 104 of FIG. 1) are generated at 404. The tables are generated, for example, in a reporting database, which may later be used to combine with code coverage trace data to generate code coverage reports. The tables may be generated at a substantially concurrent time as the parsing of the source code, and can involve metadata for instrumented stored procedures, functions and/or triggers at 406, in the source code. Further, the tables may be generated for metadata from code structure of procedures, functions, and/or triggers in the source code at 408. Additionally, tables may be generated for metadata from procedure calls at 410, and from the original source code at 412.

It will be appreciated that metadata can involve a variety of information about a particular item or group of items in the source code, and the amount and scope of metadata is not limited by this method. As an example, metadata involving a source code procedure, at 406, may comprise information about where the procedure is located in the source code, how many executable statements are located in the procedure, and if a call to another procedure is made. In this exemplary method 400, the generated tables for metadata are populated with the metadata at 414. In this example, populating the data coverage tables may occur at a substantially concurrent time as both parsing the source code and generating the data coverage tables. However, this method does not limit a time at which data coverage tables may be generated and/or populated.

In FIG. 5, an embodiment of an exemplary method 500 for code testing 502 (e.g., as in 110 and 112 of FIG. 1) is illustrated. In this exemplary embodiment 500, code testing 502 involves using instrumented code (e.g., as generated in 106 of FIG. 1) in a SQL server system, in place of the source code, at 504. As an example, in order to test which parts of a particular SQL source code execute during application testing run-time in a SQL server system (code coverage), the instrumented code can be used (injected) into the server system instead of the source code.

At 506, code coverage testing is conducted and involves, for example, running SQL Profiler on the SQL server system while the instrumented code is being tested in the server system (run-time), at 508. SQL Profiler can obtain trace data from the instrumented code at 510. As an example, SQL Profiler can operate a performance analysis on the SQL server system during run-time. This analysis can trace information as it is sent to and from databases in the system. In this example, if an executable statement is executed during runtime, the non-executable T-SQL statements, injected at the beginning of the executable statements, will cause the unique identification to be recorded in code coverage tables in a database. The SQL Profiler can monitor this activity and generate trace data, for example, showing which executable statements were executed during run-time.

At 512, code coverage data is generated, which involves mapping the trace data (e.g., generated by the SQL Profiler) to metadata previously generated for the source code at 514 (e.g., metadata tables generated and populated in 108 of FIG. 1). In this example, the mapped metadata can be imported to a reporting database at 516. At 518, code coverage reports can be generated from the reporting database using a code coverage reporting tool.

In one aspect, reporting of the code coverage can be handled in a variety of ways. As an example, applications may be run in several databases, having several partitions. In this example, trace data may be generated in these several databases and/or several partitions, and may have to be merged into a reporting database to generate coverage reports. It will be appreciated that this method is not intended to limit an ability to report code coverage information. As a further example, the metadata and the trace data may be imported into a reporting database, where they can be combined using a reporting tool. Further, the combined metadata and trace data may be sent to a reporting tool to generate reports separately. Also, a variation of these techniques may be used to combine and/or report the code coverage information with or without the use of a reporting tool.

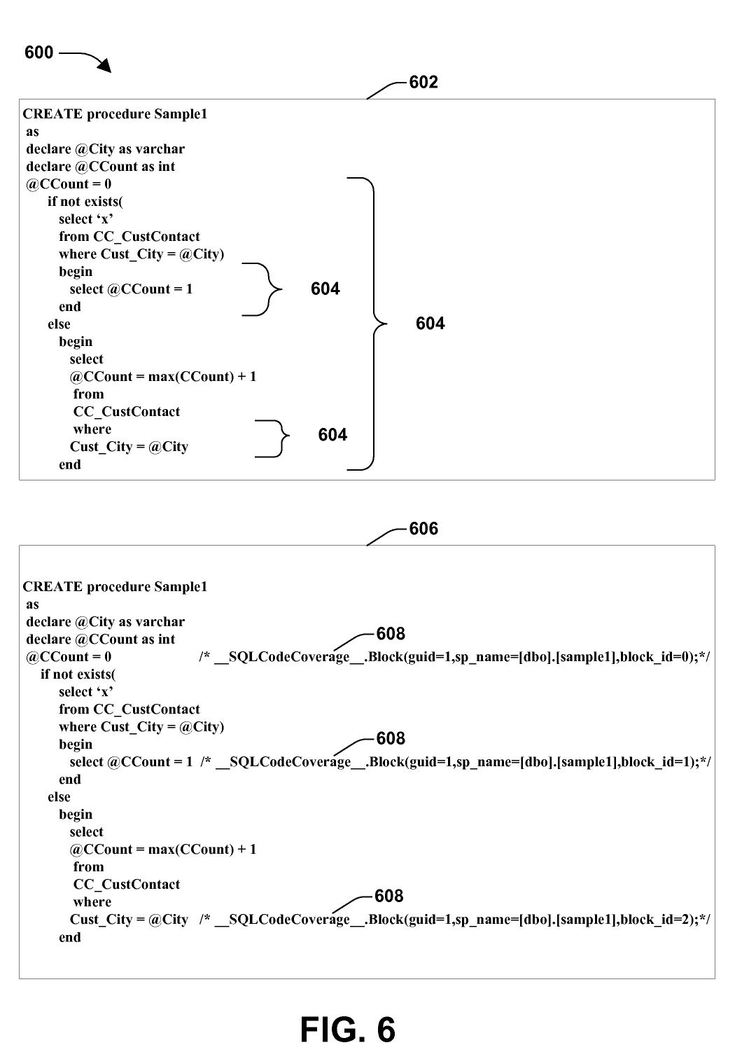

FIG. 6 illustrates an example 600 of source code instrumentation. In the example 600, an example of original SQL source code 602 contains three blocks containing executable statements 604. After the source code has been parsed (e.g., as in 104 of FIG. 1), and non-executable T-SQL code statements are generated, containing unique identification keys (e.g., as in 304 of FIG. 3), the non-executable statements 608 are injected in to source code 602 at a beginning of the respective blocks 604, generating instrumented code 606. In this example, the non-executable statements 608 contain a unique id (block_id=0, 1, 2) for the respective blocks of executable statements. Further, the non-executable statements have been placed at a beginning of the respective blocks of executable statements so that, for example, if a respective block of executable statements is executed during run-time, the non-executable T-SQL code statement will send the unique identification key to a reporting database, resulting in trace data for that block of executed statements.

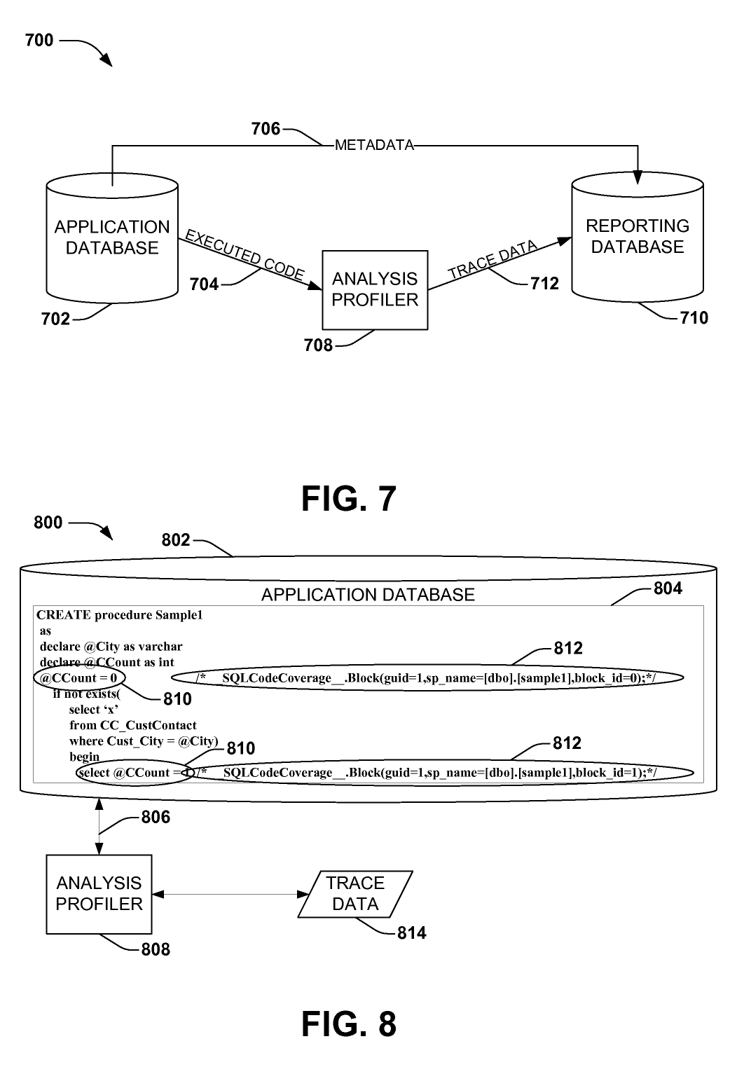

FIG. 7 is a block diagram of an exemplary implementation 700 of a method for source code coverage testing as described herein, illustrating one embodiment of a flow of data. An application database 702 (e.g., an SQL server system) may contain source code to be executed. In order to perform code coverage testing (e.g., as in 100 of FIG. 1) metadata coverage tables can be generated for the source code, and the metadata can be sent during source code instrumentation 706 to a reporting database 710 (e.g., as in 108 of FIG. 1).

The source code in the application database 702 is replaced with instrumented code and coverage tests are run (e.g., the instrumented code is run in the application database 702 while being monitored by an analysis profiler, as in 500 of FIG. 5), resulting in executed code 704 being subjected to an analysis profiler 708 (e.g., SQL Profiler). The analysis profiler 708 collects trace data 712 during run-time and forwards it to the reporting database 710. In this example, the reporting database 710 can map the trace data 712, collected during runtime, to executable statements in the source code using the metadata, generated during instrumentation 706, to generate code coverage reports for the source code.

FIG. 8 is a block diagram of an exemplary embodiment 800 illustrating how code coverage data may be collected. In this exemplary embodiment 800, instrumented SQL code 804 (in this illustration only a portion of the code is shown) has been injected into an application database 802. In this example, instrumentation is apparent by the presence of non-executable T-SQL code statements 812 located at a beginning of executable statements 810 in the source code 804.

In this example, when the instrumented code 804 is run in the application database 802 (e.g., an SQL server system), an analysis profiler 808 (e.g., SQL Profiler) is activated and it monitors 806 the application database 802 during run-time of the instrumented code 804. As the instrumented code is executed and an executable statement 810 (e.g., beginning at “@CCount=0”) is executed, the corresponding T-SQL statement 812 sends a unique identification key (e.g., block_id=0), which is captured by the monitoring 806 of the application database 802 by the analysis profiler 808. The analysis profiler 808 generates trace data 814 that identifies the unique identification key in the T-SQL statement 812.

The trace data 814 may be used by combining it with metadata generated during source code instrumentation (e.g., as in 108 of FIG. 1), to map which executable statements in the source code were executed during run-time on the application database 802. In this example, only those executable statements that were executed during run-time in the application database 802 will result in the analysis profiler 808 creating trace data 814. If an executable statement is not executed, the corresponding T-SQL instrumentation code 812 will not send its unique identification key; and the analysis profiler 808 will not detect anything for that statement.

As described above, source code coverage typically involves testing coverage (e.g., execution of code) of the source code during an application test. Such application tests may involve a variety of situations, designed to determine the application's functionality. It will be appreciated that source code coverage, using this techniques described herein, is not limited to application testing, but may be used in a variety of circumstances that may call for code coverage testing devised by those skilled in the art. As an example, code coverage testing may be used to test an application's code coverage during normal operations in an operating system.

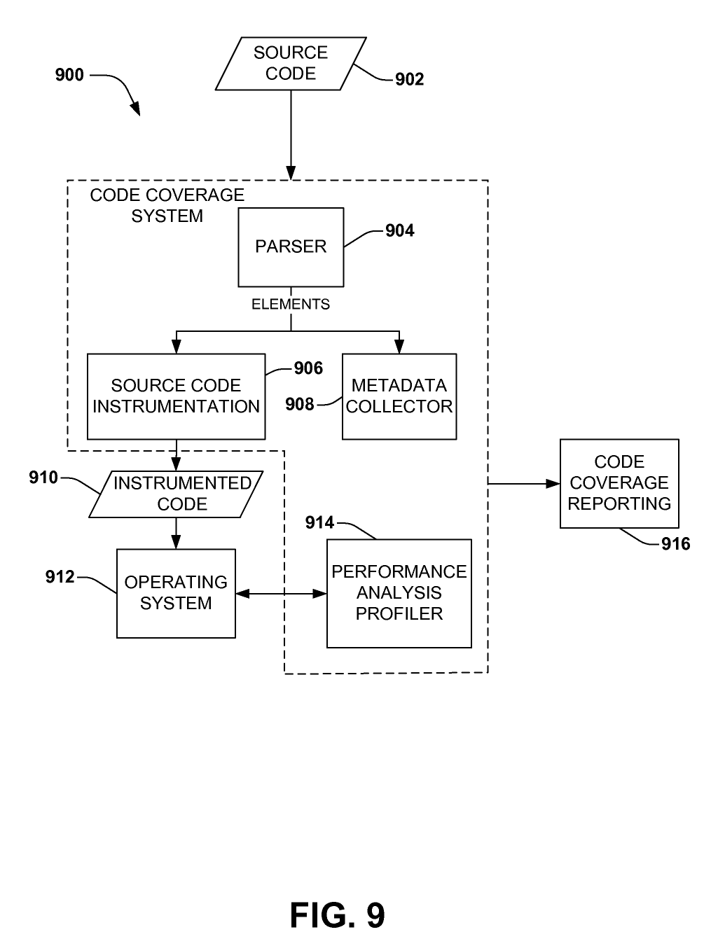

A system may be devised for conducting source code coverage testing using an operating system performance analysis profiler. FIG. 9 is a component block diagram illustrating an exemplary system 900 for source code coverage testing. The exemplary code coverage system 900 comprises a source code parser 904, which receives source code 902, and is configured to identify elements in the source code 902. The exemplary code coverage system 900 further comprises a source code instrumentation component 906 and a metadata collector 908. The source code instrumentation component 906 receives information concerning executable statements in the elements of the source code 902 from the source code parser 904, and is configured to generate instrumented code 910 by injecting non-executable code statements in the source code 902. The metadata collector 908 receives information about the elements in the source code 902 from the source code parser 904, and is configured to collect metadata from the information about the elements of the source code, for example, to be later used for code coverage reporting. Additionally, the code coverage system 900 further comprises a performance analysis profiler 914 (e.g., SQL Profiler), which monitors an operating system 912 (e.g., SQL server system) that is running the instrumented code 910, and is configured to perform code tracing on the instrumented code 910 running in the operating system 912. The system 900 can then output, such as via a code coverage reporting component 916, for example, one or more code coverage reports which give an indication of which parts of the source code 902 were executed during run-time testing.

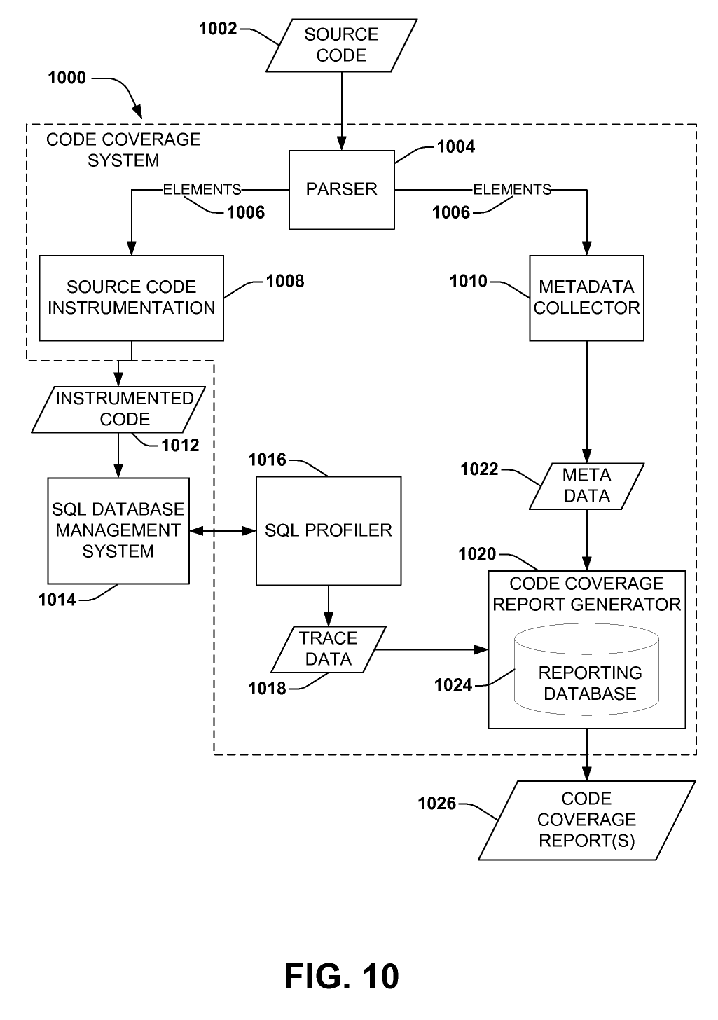

FIG. 10 is a component block diagram illustrating another exemplary system 1000 for source code coverage testing. In this embodiment, the exemplary system 1000 comprises a source code parser 1004, a source code instrumentation component 1008, and a metadata collector 1010 (e.g., similar to FIG. 9). However, in this embodiment metadata 1022 collected by metadata collector 1010 is sent to a code coverage report generator 1020. Further, in this embodiment, as an example, the operating system is a SQL database management system 1014, which can execute instrumented code 1012 (e.g., SQL source code injected with T-SQL non-executable statements containing unique identification keys) generated by the source code instrumentation component 1008. As the instrumented code 1012 is running on the SQL database management system 1014, the run-time is monitored by a SQL profiler 1016, which generates trace data 1018, and sends it to the code coverage report generator 1020.

In this embodiment, the code coverage report generator 1020 comprises a reporting database 1024, which receives the metadata 1022 and the trace data 1018. The code coverage report generator 1020 is configured to map the code trace data 1018 to the source code 1002, using the metadata 1022, for example, so that those executable statements in the source code that were executed during run-time in the SQL database management system 1014 can be identified. The code coverage report generator 1020 is further configured to generate one or more code coverage reports 1026 for the executed code, for example, which may tell a user which parts of the source code 1002 were executed during run-time.

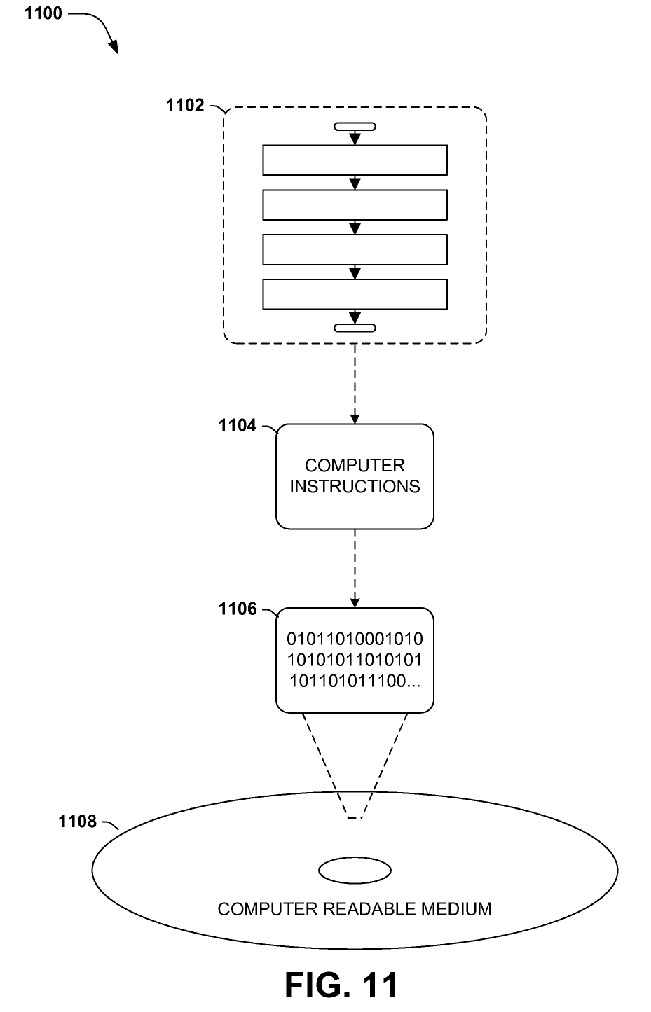

Still another embodiment involves a computer-readable medium comprising processor-executable instructions configured to implement one or more of the techniques presented herein. An exemplary computer-readable medium that may be devised in these ways is illustrated in FIG. 11, wherein the implementation 1100 comprises a computer-readable medium 1108 (e.g., a CD-R, DVD-R, or a platter of a hard disk drive), on which is encoded computer-readable data 1106. This computer-readable data 1106 in turn comprises a set of computer instructions 1104 configured to operate according to one or more of the principles set forth herein. In one such embodiment 1100, the processor-executable instructions 1104 may be configured to perform a method for source code coverage testing, such as the exemplary method 100 of FIG. 1, for example. In another such embodiment, the processor-executable instructions 1104 may be configured to implement a system for source code coverage testing, such as the exemplary system 900 of FIG. 9, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

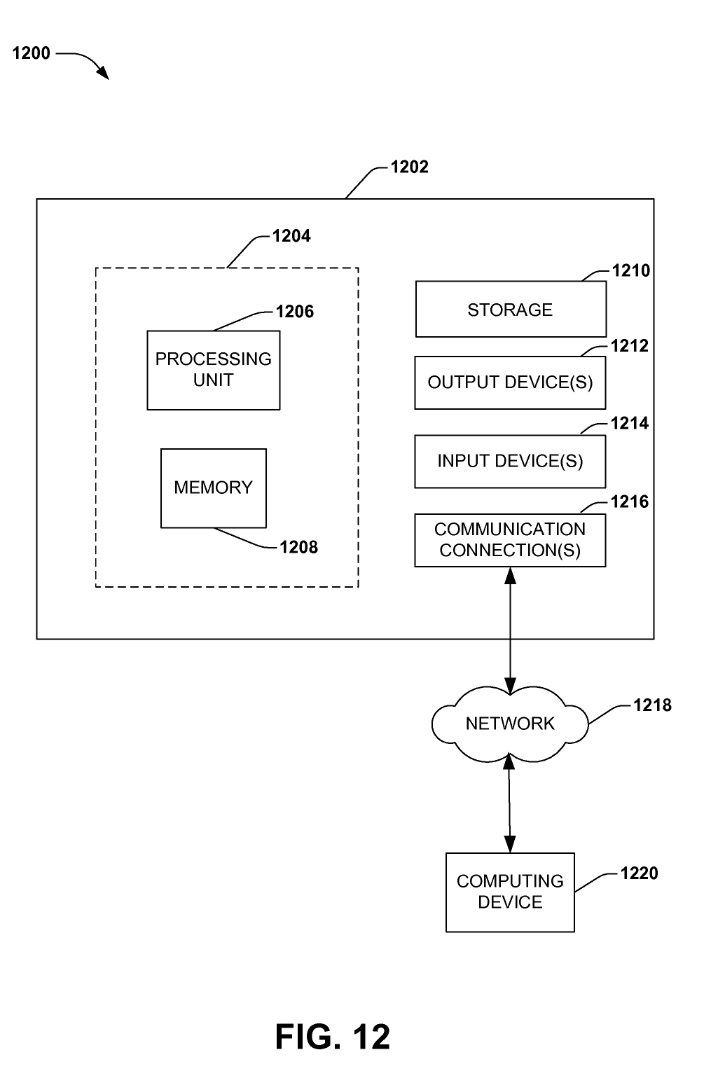

FIG. 12 illustrates an example of a system 1200 comprising a computing device 1202 configured to implement one or more embodiments provided herein. In one configuration, computing device 1204 includes at least one processing unit 1206 and memory 1208. Depending on the exact configuration and type of computing device, memory 1208 may be volatile (such as RAM, for example), non-volatile (such as ROM, flash memory, etc., for example) or some combination of the two. This configuration is illustrated in FIG. 12 by dashed line 1204.

In other embodiments, device 1202 may include additional features and/or functionality. For example, device 1202 may also include additional storage (e.g., removable and/or non-removable) including, but not limited to, magnetic storage, optical storage, and the like. Such additional storage is illustrated in FIG. 12 by storage 1210. In one embodiment, computer readable instructions to implement one or more embodiments provided herein may be in storage 1210. Storage 1210 may also store other computer readable instructions to implement an operating system, an application program, and the like. Computer readable instructions may be loaded in memory 1208 for execution by processing unit 1206, for example.

The term “computer readable media” as used herein includes computer storage media. Computer storage media includes volatile and nonvolatile, removable and non-removable media implemented in any method or technology for storage of information such as computer readable instructions or other data. Memory 1208 and storage 1210 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1202. Any such computer storage media may be part of device 1202.

Device 1202 may also include communication connection(s) 1216 that allows device 1202 to communicate with other devices. Communication connection(s) 1216 may include, but is not limited to, a modem, a Network Interface Card (NIC), an integrated network interface, a radio frequency transmitter/receiver, an infrared port, a USB connection, or other interfaces for connecting computing device 1202 to other computing devices. Communication connection(s) 1216 may include a wired connection or a wireless connection. Communication connection(s) 1216 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1202 may include input device(s) 1214 such as keyboard, mouse, pen, voice input device, touch input device, infrared cameras, video input devices, and/or any other input device. Output device(s) 1212 such as one or more displays, speakers, printers, and/or any other output device may also be included in device 1202. Input device(s) 1214 and output device(s) 1212 may be connected to device 1202 via a wired connection, wireless connection, or any combination thereof. In one embodiment, an input device or an output device from another computing device may be used as input device(s) 1214 or output device(s) 1212 for computing device 1212.

Components of computing device 1202 may be connected by various interconnects, such as a bus. Such interconnects may include a Peripheral Component Interconnect (PCI), such as PCI Express, a Universal Serial Bus (USB), firewire (IEEE 8394), an optical bus structure, and the like. In another embodiment, components of computing device 1202 may be interconnected by a network. For example, memory 1208 may be comprised of multiple physical memory units located in different physical locations interconnected by a network.

Those skilled in the art will realize that storage devices utilized to store computer readable instructions may be distributed across a network. For example, a computing device 1220 accessible via network 1218 may store computer readable instructions to implement one or more embodiments provided herein. Computing device 1202 may access computing device 1220 and download a part or all of the computer readable instructions for execution. Alternatively, computing device 1202 may download pieces of the computer readable instructions, as needed, or some instructions may be executed at computing device 1202 and some at computing device 1220.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for source code coverage testing, the method comprising:
parsing source code into elements;
generating instrumented code comprising injecting non-executable statements in one or more locations in the source code, the one or more locations comprising one or more positions that indicate whether an executable statement is executed during run-time;
generating coverage data tables for respective elements identified during the parsing of the source code;
injecting the instrumented code into an operating system; and
conducting coverage testing using a performance analysis profiler.

2. The method of claim 1, parsing the source code comprising:
identifying respective executable statements; and
identifying calls made from one procedure to another.

3. The method of claim 2, identifying respective executable statements within one or more identified elements, the elements comprising at least one of:
specified, stored procedures;
specified functions; and
specified triggers.

4. The method of claim 2, identifying respective executable statements comprising:
identifying those elements that will be instrumented;
identifying a code structure for the elements; and
identifying original source code.

5. The method of claim 1, generating instrumented code comprising generating unique keys for respective non-executable statements injected into the source code.

6. The method of claim 1, a location in the source code that can identify whether an executable statement is executed comprising a beginning of respective executable statement of respective blocks of the source code.

7. The method of claim 1, generating coverage data tables comprising:
generating tables in a database; and
populating the coverage data tables with metadata associated with the parsed elements of the source code.

8. The method of claim 7, the metadata comprising:
information concerning one or more instrumented stored procedures, functions; and triggers;
information concerning code structure for one or more procedures, functions; and triggers;
information concerning calls made from one procedure to another; and
information concerning original source code.

9. The method of claim 1, the operating system comprising a database management system.

10. The method of claim 9, the database management system comprising a SQL server system.

11. The method of claim 1, the performance analysis profiler comprising a SQL profiler.

12. The method of claim 7, comprising:
obtaining trace data from the code coverage testing;
mapping the trace data to the source code using the metadata; and
generating one or more reports using mapped results.

13. The method of claim 12, comprising parsing elements of the trace data results.

14. The method of claim 12, comprising importing mapped results to a reporting database.

15. The method of claim 1, comprising merging profiler data from a plurality of databases and partitions.

16. A system for source code coverage testing, the system comprising:
a source code parser configured to identify elements of the source code;
a source code instrumentation component configured to generate instrumented code comprising injecting non-executable code into the source code;
a metadata collector configured to collect metadata from the source code for the identified elements; and
a performance analysis profiler configured to perform code tracing on the instrumented code running in an operating system.

17. The system of claim 16, the performance analysis profiler comprising a SQL profiler.

18. The system of claim 16, the operating system comprising a database management system.

19. The system of claim 16 comprising a code coverage report generator configured to:
map code trace data to the source code using the metadata; and
generate one or more code coverage reports for executed code.

20. A method for source code coverage testing, the method comprising:
parsing source code into elements comprising:
identifying respective executable statements within one or more identified elements, the element comprising at least one of:
specified, stored procedures;
specified, stored functions; and
specified, stored triggers; and
identifying calls made from one procedure to another;
generating instrumented code comprising:
injecting non-executable statements in one or more locations in the source code, the one or more locations comprising a beginning of respective executable statement of respective blocks of the source code; and
generating unique keys for respective non-executable statements injected into the source code;
generating coverage data tables for respective elements identified during the parsing of the source code comprising:
generating tables in a database; and
populating the code coverage tables with metadata associated with the parsed elements of the source code;
injecting instrumented code into an SQL Server system; and
conducting coverage testing using SQL profiler.
